(19) United States
(12) Patent Application Publication
(10) Pub. No.: US 2008/0134034 A1
(43) Pub. Date: Jun. 5, 2008

(54) METHOD AND SYSTEM FOR PROVIDING SOFTWARE ROBOT SERVICE

(75) Inventor: HO SEOK SEO, SUNGNAM-SI (KR)

Correspondence Address: KNOBBE MARTENS OLSON & BEAR LLP, 2040 MAIN STREET, FOURTEENTH FLOOR, IRVINE, CA, 92614, US

(73) Assignee: KT CORPORATION, SUNGNAM-SI (KR)

(21) Appl. No.: 11/949,696

(22) Filed: Dec. 3, 2007

Related U.S. Application Data
(63) Continuation of application No. PCT/KR2006/002164, filed on Jun. 5, 2006.

(30) Foreign Application Priority Data
Jun. 3, 2005 (KR) 10-2005-0047914

(51) Int. Cl. G06F 3/048

(52) U.S. Cl. 715/706

(57) ABSTRACT

Disclosed are a method and a system for servicing a SOBOT (SOftware roBOT). The SOBOT service can be supplied to various terminals such as a mobile terminal (a portable phone), an IPTV or the like, and if the owner goes out of home with carrying the mobile phone or returns home, the present invention can automatically move the SOBOT from a computer to the mobile phone or the mobile phone to the computer.

### CROSS-REFERENCE TO RELATED PATENT APPLICATIONS

This application is a continuation application under 35 U.S.C. § 365(c) of International Application No. PCT/KR2006/002164, filed Jun. 5, 2006 designating the United States. International Application No. PCT/KR2006/002164 was published in English as WO2006/129993 A1 on Dec. 7, 2006. This application further claims the benefit of the earlier filing date under 35 U.S.C. § 365(b) of Korean Patent Application No. 10-2005-0047914 filed Jun. 3, 2005. This application incorporates herein by reference the International Application No. PCT/KR2006/002164 including the International Publication No. WO2006/129993 A1 and the Korean Patent Application No. 10-2005-0047914 in their entirety.

### BACKGROUND

1. Field

The present disclosure relates to a method and a system for servicing a SOBOT (SOftware roBOT); and, more particularly, to a method for servicing a SOBOT capable of providing a service to allow a user to breed a cyber pet, i.e., the SOBOT, at a virtual space.

2. Discussion of the Related Technology

Recently, demands for various pets have been drastically increased, and also interests and an availability ratio for cyber pets capable of breeding without giving inconvenience to neighboring have been increased. Herein, as the cyber pets are pets existing at a virtual space, if a user, e.g., owner, performs a virtual breeding (bring up) behavior such as ‘feeding food’ ‘playing’ or the like, a state of the pets is determined according to this and an image of the pets changed according to the state is displayed. The cyber pets are manufactured by software so as to be mainly installed on a computer or a mobile phone or a cyber pet service is supplied to a user's computer at a server through Internet. Since these cyber pets do not have a physical shape, recently it is used as a term of ‘SOBOT’ (an abbreviation of SOftware and roBOT).

As like the above described, as for one example of a technology for supplying a cyber pet service, a publication patent No. 2001-57829 discloses a technology related to ‘METHOD FOR DISTRIBUTING AND DRAWING CYBER PETS ON NETWORK AND RECORDING MEDIUM CAPABLE OF BEING READ COMPUTER RECORDED BY THE METHOD’. More specifically, the above described publication patent is a method that allocates a plurality of personal home pages to a plurality of users on the network and distributes the cyber pets to allow the users to directly breed the cyber pets at their home pages. But, according to the above described publication patent, since it is a method that the users directly connect to the home page so as to loading their cyber pets, if the users go out of home during breeding the cyber pets at computers existing in their homes, the users are capable of watching the cyber pets only when they connect their home pages through a wireless Internet by using mobile terminals. On the contrary, if the users return home, the users are capable of watching the cyber pets only when they connect their home pages through Internet by using the computers.

As like this, in case when the users breed the cyber pets using various terminals, there exist various troublesome that they connect their home pages at each terminal every when they breed their pets. Due to these troublesome, the users scarcely visit the cyber pets and there are problems that an intimacy felt when the cyber pets always resides at sides of the users is deteriorated.

The foregoing discussion in this section is to provide general background information, and does not constitute an admission of prior art.

### SUMMARY

An aspect of the present invention provides a method for servicing a SOBOT capable of providing a service to automatically move a SOBOT such as a cyber pet from a computer to a mobile terminal or from the mobile terminal to the computer when an owner of the cyber pet goes out of home or returns home.

One aspect of the present invention provides a method for servicing a SOBOT (SOftware roBOT) to automatically move the SOBOT between a mobile terminal and a computer placed at a predetermined area range based on position information of the mobile terminal by a SOBOT service system connected to a system. Particularly, the method includes the steps of: (a) receiving position information of a mobile terminal of a subscriber in real time from the system; (b) determining whether the mobile terminal is deviated from the predetermined area range or enters the predetermined area range based on the position information of the step (a); and (c) selecting any one of the following steps (c1) and (c2): (c1) if the mobile terminal is deviated from the predetermined area range as a result determined at the step (c1), after an execution finish command of a SOBOT program is transmitted to the computer of the subscriber, transmitting an update SOBOT information and the execution command of the SOBOT program to the mobile terminal; and (c2) if the mobile terminal enters the predetermined area range as a result determined at the step (c1), after an execution finish command of a SOBOT program is transmitted to the mobile terminal, transmitting the update SOBOT information and the execution command of the SOBOT program to the computer.

The updated SOBOT information at the step (c1) is SOBOT information updated at a database of the SOBOT system after a final correction time of the SOBOT information stored at the mobile terminal and the updated SOBOT information at the step (c2) is SOBOT information updated at the database of the SOBOT service system after the final correction time of the SOBOT information stored at the computer.

The step (c1) includes the steps of: inquiring of the mobile terminal whether or not to execute the SOBOT program when the mobile terminal is deviated from the predetermined area region as a result determined from the step (b); and transmitting the update SOBOT information and the execution program of the SOBOT program to the mobile terminal, when the subscriber accepts the execution of the SOBOT program through the mobile terminal, after an execution finish command of the SOBOT program is transmitted to the computer of the subscriber; and the step (c2) includes the steps of: inquiring of the computer of the subscriber whether or not to execute the SOBOT program when the mobile terminal enters the predetermined area region as a result determined from the step (b); and transmitting the update SOBOT information and the execution command of the SOBOT program to the computer, when the subscriber accepts the execution of the SOBOT program through the computer of the subscriber, after the execution finish command of the SOBOT program is transmitted to the mobile terminal.

Before the step (a), the method further includes the steps of: applying a service subscription by inputting information of the subscriber including the mobile terminal of the subscriber by being connected to the SOBOT service system through the computer of the subscriber; and registering the predetermined area range by the subscriber based on a position information when the SOBOT service system receives the position information of the mobile terminal of the subscriber from the system and transmits the received position information to the computer.

Before the step (a) and after a step of registering the predetermined area range, the method further includes the steps of: transmitting the SOBOT program to the computer and the mobile terminal, wherein the SOBOT program includes: a control unit for controlling each module; a breeding unit supplying module for supplying a breeding unit of the SOBOT to the subscriber; a breeding information reception module for receiving breeding information inputted from the subscriber; a SOBOT state display module for calculating a current state and/or a behavior of the SOBOT based on the SOBOT information to display the calculated results; a SOBOT information transmission module for transmitting the updated SOBOT information to the SOBOT service system; and an execution control module for executing or finishing a program receiving an execution command or an execution finish command of the SOBOT program from the SOBOT service system.

The execution finish command of the SOBOT program at the step (c1) is to be transmitted to the computer of the subscriber via a home gateway of the subscriber and the execution command of the SOBOT program at the step (c2) is to be transmitted to the computer of the subscriber via a home gateway of the subscriber.

Another aspect of the present invention provides a system for servicing a SOBOT to automatically move the SOBOT between a mobile terminal and a computer placed at a predetermined area range based on position information of the mobile terminal linked to a system, the system including: a subscriber information database at which area range information is stored according to each of subscriber mobile terminals; a position information analyzing module for receiving position information of the subscriber mobile terminal from the system in real time and for determining whether the mobile terminal is deviated from the predetermined area range or enters the predetermined area range by searching the area region of the subscriber mobile terminal stored at the subscriber information database; an execution control module for controlling an execution and a finish of the SOBOT program by transmitting the mobile terminal of the subscriber or a SOBOT program execution command or a SOBOT program execution finish command to the computer through an information communication network; a SOBOT information reception module for receiving SOBOT information from the mobile terminal or the computer while executing the SOBOT program at the mobile terminal or the computer and for storing the received SOBOT information at the data base; a SOBOT information supplying module for transmitting the updated SOBOT information among the SOBOT information stored at the database to the mobile terminal or the computer; and a control unit for transmitting the SOBOT program execution command and the updated SOBOT information to the computer by calling the execution control module and the SOBOT information supplying module, wherein the control unit transmits the SOBOT program execution finish command to the computer by calling the execution control module when it is determined by the position information analyzing module that the mobile terminal deviates from the predetermined area region, the control unit transmits the SOBOT program execution command and the updated SOBOT information to the mobile terminal by calling the execution control module and the SOBOT information supplying module, and the control unit transmits the SOBOT program execution finish command to the mobile terminal by calling the execution control module when it is determined by the position information analyzing module that the mobile terminal enters the predetermined area region.

The system further includes an execution inquiry module, after inquiring of the computer of the subscriber or the mobile computer whether or not to execute the SOBOT program, for receiving the result and transmitting the received result to the execution control module, wherein the execution control module is a module the SOBOT program execution command and the SOBOT program execution finish command are transmitted to the mobile terminal or the computer only in case of data related to the execution acceptance is received by the execution inquiry module.

The SOBOT program includes: a breeding unit supplying module for supplying a plurality of units to breed the SOBOT by the subscriber; a breeding information reception module, if the subscriber selects at least one among the breeding units through an input device of the computer or the mobile terminal; a SOBOT information database for storing a previously set SOBOT birth place information, the SOBOT breeding information stored by the breeding information reception module and SOBOT state information according to the previously set SOBOT birth place information and/or the SOBOT breeding information; a SOBOT image database for storing files of images such as a picture, a drawing or a moving picture of the SOBOT according to a state or a behavior of the SOBOT; a SOBOT state display module for calculating a current state of the SOBOT based on the SOBOT information stored at the SOBOT information database and reading the images matching to the current state and/or the behavior of the SOBOT from the SOBOT image database to display the read images; a SOBOT information transmission module for transmitting the SOBOT information updated at the SOBOT information database during the execution of the SOBOT program to the SOBOT service system through the information communication network; and an execution control module for controlling an execution and a finish of the program according to an execution command or an execution finish command of the SOBOT program from the SOBOT service system.

The files of images such as a picture, a drawing or a moving picture of the SOBOT include an image file of a pet or an image file of a person.

Another aspect of the present invention provides a method for servicing a SOBOT to automatically move the SOBOT between a mobile terminal and a computer placed at a predetermined area range based on position information of the mobile terminal by a SOBOT service system connected to a system, the method including the steps of: (a) if the system transmits deviation information or entrance information of the mobile terminal of a subscriber, receiving the transmitted information; (b) selecting any one of the following steps (c1) and (c2): (b1) if the deviation information is received at the step (a), after an execution finish command of a SOBOT program is transmitted to the computer of the subscriber, transmitting an update SOBOT information and an execution command of the SOBOT program to the mobile terminal; and (b2) if the entrance information is received at the step (a), after an execution finish command of a SOBOT program is transmitted to the mobile terminal, transmitting the update SOBOT information and the execution command of the SOBOT program to the computer.

One aspect of the present invention provides a system for servicing a SOBOT to automatically move the SOBOT between a mobile terminal and a computer placed at a predetermined area range based on position information of the mobile terminal linked to a system, the system including: a position information reception module for receiving deviation information or entrance information of the mobile terminal of a subscriber from the system; an execution control module for controlling an execution and a finish of the SOBOT program by transmitting the mobile terminal of the subscriber or a SOBOT program execution command or a SOBOT program execution finish command to the computer through an information communication network; a SOBOT information reception module for receiving SOBOT information from the mobile terminal or the computer while executing the SOBOT program at the mobile terminal or the computer and for storing the received SOBOT information at the data base: a SOBOT information supplying module for transmitting the updated SOBOT information among the SOBOT information stored at the database to the mobile terminal or the computer; and a control unit for transmitting the SOBOT program execution command and the updated SOBOT information to the computer by calling the execution control module and the SOBOT information supplying module, wherein the control unit transmits the SOBOT program execution finish command to the computer by calling the execution control module when the deviation information of the mobile terminal is received by the position information reception module, the control unit transmits the SOBOT program execution command and the updated SOBOT information to the mobile terminal by calling the execution control module and the SOBOT information supplying module, and the control unit transmits the SOBOT program execution finish command to the mobile terminal by calling the execution control module when the entrance information is received by the position information reception module.

In accordance with one aspect of the present invention, when an owner goes out of home or returns home, since a SOBOT such as a cyber pet automatically moves from a computer to a mobile terminal or from the mobile terminal to the computer, there is not occurred inconvenience that a subscriber directly connects to a SOBOT service system when the subscriber goes out of home or returns home.

In accordance with another aspect of the present invention, since a SOBOT automatically moves along a movement of the owner, the subscriber feels intimacy that the SOBOT always keeps close to the subscriber.

In accordance with still another aspect of the present invention, since almost processes to activate a SOBOT are performed at each terminal such as a mobile terminal and a computer, embodiments of the present invention provides a SOBOT service to rapidly respond to a behavior of an owner according to a behavior of an owner without depending on a data transmission speed.

In accordance with still another aspect of the present invention, amuse and various services are provided to a user by connecting a SOBOT character image to a service to display a character such as an errand service, a chatting service, a diary service or the like.

### BRIEF DESCRIPTION OF THE DRAWINGS

These and other features, aspects, and advantages of embodiments of the present invention will be more fully described in the following detailed description, taken accompanying drawings. In the drawings:

FIG. 1 shows a network construction diagram of a SOBOT service method in accordance with an embodiment of the present invention;

FIG. 2 is a construction diagram of a SOBOT service system in accordance with one embodiment of the present invention;

FIG. 3 represents a construction diagram of a SOBOT program stored at a SOBOT program storage place shown in FIG. 2;

FIG. 4 depicts a flow chart of a SOBOT service method in accordance with one embodiment of the present invention;

FIG. 5 illustrates a diagram showing the SOBOT service method shown in FIG. 4 according to network subjects;

FIG. 6 is a construction diagram of a SOBOT service system in accordance with another embodiment of the present invention; and

FIG. 7 is a flow chart of a SOBOT service method in accordance with another embodiment of the present invention.

### DETAILED DESCRIPTION OF EMBODIMENTS

Hereinafter, various embodiments of the present invention will be described in detail with reference to the accompanying drawings. At first, terms or words used in the detailed description of the present disclosure and claims should not be interpreted as a conventional meaning or a dictionary meaning, but they are interpreted as meanings and concepts matching to a technical scope of the present disclosure based on a principle that the inventor can appropriately define concepts of terms to describe embodiments of the invention of the inventor. Therefore, since embodiments described in the present specification and constructions shown in the accompanying drawings are only the embodiments of the present invention and cannot represent all of the technical scopes of the present invention, it should be understood that they are replaced with various equivalents and modifications at the time of filing the present application.

At first, in the present specification, a term of ‘SOBOT’ is used as a meaning such as ‘cyber pet’ or ‘cyber character’ for the sake of convenience.

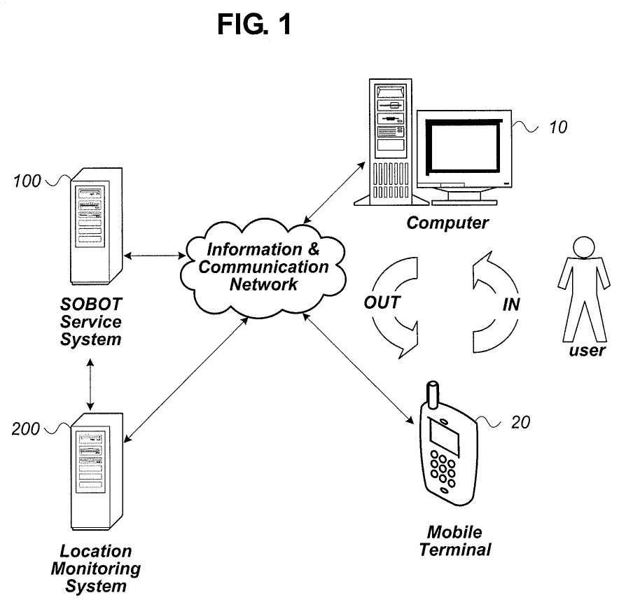

FIG. 1 shows a network construction diagram of a SOBOT service method in accordance with an embodiment of the present invention. Referring to FIG. 1, a SOBOT service system 100 is linked to a mobile terminal 20 and a computer 10 of a subscriber through an information communication network, and is linked to a system 200 through the information communication network.

The information communication network means data communication networks that connected to each other by various networks including LAN, WAN, intranet and an inner network similar to these, herein it should be understood that they includes a cable network including a dedicated network and PSTN as well as includes a wireless network such as a portable internet, a satellite communication network and IMT-2000.

As the computer 10 is a terminal that exists at home or company of a subscriber, it commonly calls all terminals without having mobility among terminals such as a desktop, a notebook, an IPTV or the like capable of accessing to the SOBOT service system 100. On the other hand, the computer 10 can be directly connected to a very high speed Internet network or the like, and it can be connected to the very high speed Internet network or the like through a home gateway in home.

The mobile terminal 20 generally calls all terminals having portability among terminals capable of accessing to the SOBOT service system 100. Although the mobile terminal 20 can be a cellular phone, a PCS phone, a PDA phone or the like, but the present is not limited to those.

The SOBOT service system 100 is a system to supply a SOBOT service to a mobile terminal 20 and a computer 10 of the subscriber. Herein, the SOBOT (SOftware roBOT) service calls a service for breeding (raising) a cyber pet as described above. The SOBOT service system 100 moves the SOBOT of the computer 10 to the mobile phone 20 when the subscriber goes out of home with carrying the mobile terminal 20, and the SOBOT service system 100 moves the SOBOT of the mobile terminal 20 to the computer 10 when the subscriber returns home.

The system 200 supplies the SO BOT service system 100 by acquiring geographic position information of the subscriber mobile terminal 20 as one type of LBS (Location Based Service) technology. More particularly, the system 200 is capable of transmitting position information of the mobile terminal 20 to the SOBOT service system 100 when the position of the mobile terminal 20 is changed; and, when the position information of the mobile terminal 20 is changed, after it is determined whether the mobile terminal 20 is deviated from a predetermined area region or enters the predetermined area region, the system 200 is capable of transmitting the deviation information or entrance information to the SOBOT service system 100.

It is performed by an interaction between network subjects as described above in accordance with an embodiment of the present invention.

First of all, after the subscriber subscribes to the SOBOT service, the subscriber registers an IP address (or authentication information) of the computer and an identification code, e.g., a telephone number, and an area range, e.g., a home location of the subscriber, of the mobile terminal 20 by connecting to the SOBOT service system 100 through the computer 10 or the mobile terminal 20. At this time, it is preferable to allow the subscriber to agree that the SOBOT service system 100 receives the position information of the mobile terminal 20 in real time from the system 200.

Herein, the area range means a place such as a home or a company of the subscriber where the computer 10 of the subscriber exists. The subscriber is capable of directly inputting information, e.g., a home address, related to the area range to the SOBOT service system 100; and, after the SOBOT service system 100 inquires of the system 200, the subscriber can register the position of the mobile terminal 20 of the subscriber which exists at the area range by receiving the inquiry result.

As described above, after the subscriber finishes the subscription from the SOBOT service through the computer 10 or the mobile terminal 20 or the like, the SOBOT program is downloaded from the SOBOT service system 100 and the downloaded SOBOT program is installed on the computer 10 and the mobile terminal 20. If the installation of the SOBOT program is finished, the SOBOT program is executed at the computer 10 or the mobile terminal 20 by the subscriber, and the subscriber breeds the SOBOT through a unit such as a breeding means.

If the subscriber goes out of home with carrying out the mobile terminal 20, i.e., when the mobile terminal 20 is deviated from an area range where the computer 10 exists, this fact is sensed by the system 200, the SOBOT service system 100 finishes the SOBOT program of the computer 10 and executes the SOBOT program of the mobile terminal 20.

Meanwhile, if the subscriber returns home after going out of home with carrying the mobile terminal 20, i.e., the mobile terminal 20 enters an area range where the computer exists, this fact is sensed by the system 200, the SOBOT service system 100 finishes the SOBOT program of the mobile terminal 20 and executes the SOBOT program of the computer 10.

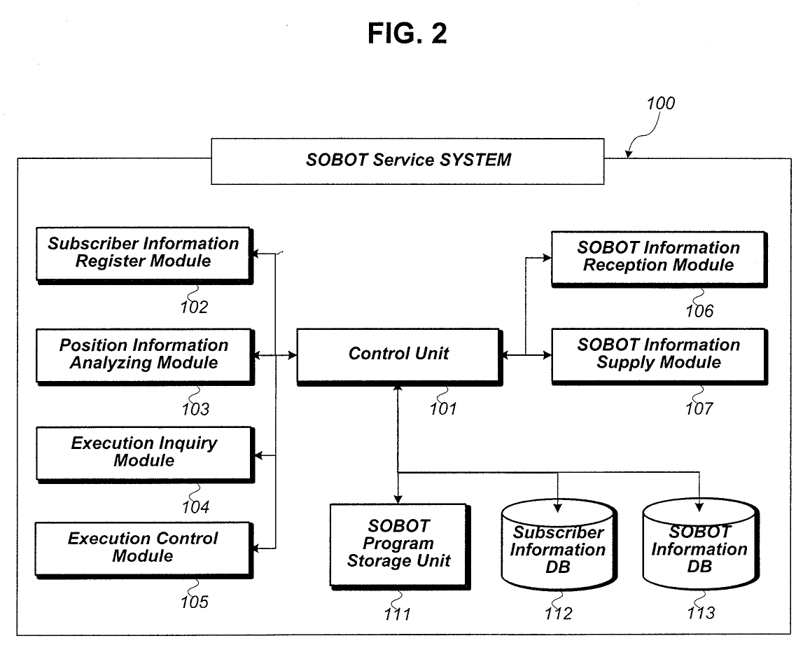

FIG. 2 is a construction diagram of a SOBOT service system in accordance with one embodiment of the present invention. Referring to the drawings, the SOBOT service system 100 includes a control unit 101, a subscriber information register module 102, a position information analyzing module 103, an execution inquiry module 104, an execution control module 105, a SOBOT information reception module 106, and a SOBOT information supply module 107, and further includes a SOBOT program storage unit 111, a subscriber information database 112, and a SOB OT information database 113.

The control unit 101 takes charge of a serial processes related to supplying the SOBOT service. More specifically, if it is determined range by the position information analyzing module 103 that the mobile terminal 20 is deviated from a predetermined area, a SOBOT program execution finish command is transmitted to the computer 10 by calling the execution control module 105 and a SOBOT program execution command and updated SOBOT information are transmitted to the mobile terminal 20 by calling the execution control module 105 and the SOBOT information supply module 107. If it is determined range by the position information analyzing module 103 that the mobile terminal 20 enters the predetermined area range, the SOBOT program execution finish command is transmitted to the mobile terminal 20 by calling the execution control module 105 and the SOBOT program execution command and the updated SOBOT information are transmitted to the computer 10 by calling the execution control module 105 and the SOBOT information supply module 107.

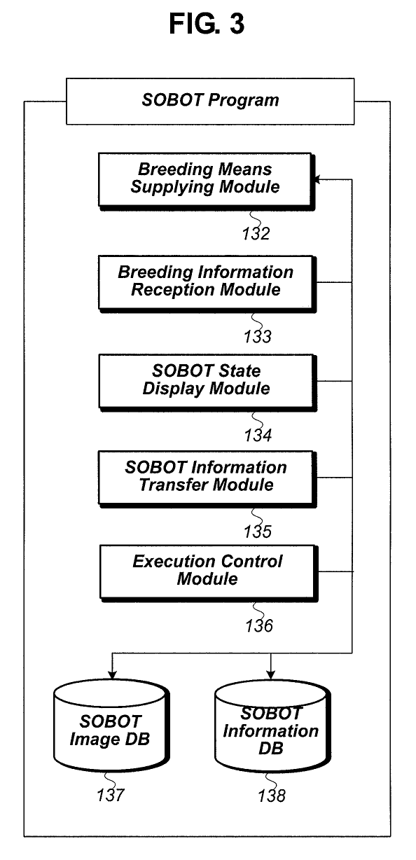

If the subscriber inputs the subscriber information through the computer 10 or the mobile terminal, the subscriber information register module 102 is a module to receive the inputted subscriber information and to store the received subscriber information at the subscriber information database 112. In registering the ‘area range’ among the subscriber information, the subscriber directly inputs the area range; and, after the position of the mobile terminal 20 is inquired, the subscriber receives this result and to register the received result. If the registration of the subscriber information is finished, the subscriber information register module 102 transmits the SOBOT program to the mobile terminal 20 and the computer 10 of the subscriber. A detailed construction of the SOBOT program is described as following together with FIG. 3.

The position information analyzing module 103 receives the position information of the subscriber mobile terminal 20 from the system 200 in real time, it determines whether the mobile terminal 20 deviates from the predetermined area range or enters the predetermined area range by searching the area range of the subscriber mobile terminal 20 stored at the a subscriber information database 112. For example, if the area range of the subscriber mobile terminal 20 is 17, Woomyeon-dong, Seocho-gu, Seoul, the position information analyzing module 103 determines whether the position information deviates from 17, Woomyeon-dong, Seocho-gu, Seoul or enters 17, Woomyeon-dong, Seocho-gu, Seoul.

After the execution inquiry module 104 inquires of the mobile terminal 20 or the computer 10 of the subscriber execution state of the SOBOT program, the execution inquiry module 104 is a module that receives the inquiry result and transmits the received result to the execution control module 105. That is, when the subscriber executes the SOBOT program by deviating from or entering the area range, since the subscriber does not want the SOBOT execution, the SOBOT program is executed after the acceptance is acquired by inquiring of the subscriber the execution state of the SOBOT program.

The execution control module 105 controls an execution and a finish of the SOBOT program by transmitting the SOBOT program execution command or the SOBOT program execution finish command to the computer 10 or the mobile terminal 20 of the subscriber.

While the SOBOT program is executed at the mobile terminal 20 or the computer 10, the SOBOT information reception module 106 is a module to receive the SOBOT information from the mobile terminal 20 or the computer 10 and to store the received SOBOT information at the SOBOT information database 113. The SOBOT information reception module 106 is capable of receiving the SOBOT information from the mobile terminal 20 or the computer 10 in real time and is capable of receiving in batch the SOBOT information changed when the SOBOT program is executed just before the SOBOT program is finished.

The SOBOT information supply module 107 is a module that transmits the updated SOBOT information among the SOBOT information stored at the SOBOT information database 113 to the mobile terminal 20 and the computer 10. The updated SOBOT information is SOBOT information, after a final correction time of the SOBOT information stored at the computer 10, updated at the SOBOT information database 113 of the SOBOT service system 100 for the case of the computer 10, and is SOBOT information, after a final correction time of the SOBOT information stored at the mobile terminal 20, updated at the SOBOT information database 113 of the SOBOT service system 100 for the case of the mobile terminal 20.

As the SOBOT program storage unit 111 is a storage space where the SOBOT program is stored, when the subscriber finishes the subscription related to the SOBOT service, the SOBOT program is a program installed on the mobile terminal 20 and the computer 10 of the subscriber. Detailed descriptions related to the construction of the SOBOT program is described hereinafter together with FIG. 3.

The subscriber information database 112 is a database where information of the subscriber is stored. More specifically, the subscriber information includes a subscriber name, a subscriber address, subscriber authentication information such as ID and/or PW, an IP address or authentication information of the computer 10, an identification code, e.g., a telephone number, an IP address or the like, of the mobile terminal 20, an area range of the subscriber or the like.

The SOBOT information database 113 is a database where SOBOT information transmitted from the mobile terminal 20 or the computer 10 of the subscriber is stored. More specifically, the SOBOT information database 113 includes a SOBOT identification code, SOBOT birth place information, SOBOT breeding information, SOBOT state information or the like. Herein, the SOBOT birth place information means a state of the SOBOT determined when the SOBOT is born, the SOBOT breeding information means breeding information inputted by the user and the SOBOT state information is information related to a state or a behavior of the SOBOT according to the SOBOT birth place information and/or the breeding information.

Embodiments of the present invention supplies the SOBOT service to the subscriber by providing the construction components as described above.

FIG. 3 represents a construction diagram of a SOBOT program stored at a SOBOT program storage place shown in FIG. 2. Referring to FIG. 3, the SOBOT program includes a breeding means supplying module 132, a breeding information reception module 133, a SOBOT state display module 134, a SOBOT information transfer module 135 and an execution control module 136, and further includes a SOBOT image database 137 and a SOBOT information database 138.

The breeding means supplying module 132 is a module to supply a breeding unit capable of breeding the SOBOT by the subscriber. The breeding unit is means for breeding the SOBOT, e.g., feeding food, playing, giving presents, putting clothes on the SOBOT, decorating the SOBOT or the like. In case when the SOBOT is a personal character in place of the pet, it is preferable that a ‘bring-up unit’ is used for in place of the ‘breeding unit’ but in the present specification the term of the ‘breeding unit’ is used for the sake of convenience.

The breeding information reception module 133 is a module that, if the subscriber selects at least one among the breeding units of the SOBOT through an input device of the computer 10 or the mobile terminal 20, the subscriber receives the breeding information and to stores the received breeding information on the SOBOT information database 138. For example, if the subscriber selects a breeding unit such as feeding food or playing, giving presents or the like, the subscriber receives the information related the selected breeding units and to stores the received information.

The SOBOT state display module 134 is a module that calculates a current state of the SOBOT based on the SOBOT information stored at the SOBOT information database 138 and displays an image of the SOBOT matching to the SOBOT state by reading the image of the SOBOT from the SOBOT image database 137. For example, if the user does not select the breeding unit of the feeding food during a predetermined time period, a ‘state that the food is not fed’ is stored at the SOBOT state information, at this time a current SOBOT state and/or a behavior is calculated as a ‘very hungry’ by the SOBOT state display module 134 and an image of the SOBOT corresponding to a state of the ‘very hungry’ e.g., an image for being enervated due to a hungry or an image for badgering the food, is displayed.

The SOBOT information transfer module 135 is a module that the SOBOT information updated at the SOBOT information database 138 is transmitted to the SOBOT service system 100 through the information communication network while the SOBOT program is executed.

The execution control module 136 is a module to control an execution and a finish of the program an execution command or an execution finish command of the SOBOT program from the SOBOT service system 100.

The SOBOT image database 137 is a database where files of an image such as a picture, a drawing or a moving picture matched to a current state or a behavior of the SOBOT are stored. Herein, the image files of the SOBOT include a pet image file or a person image file.

SOBOT information previously set or inputted by the subscriber is stored at the SOBOT information database 138. More specifically, the SOBOT information includes a SOBOT identification code, SOBOT birth place information, SOBOT breeding information, SOBOT state information or the like. More specifically, herein, the updated SOBOT information can be breeding information updated by the subscriber and SOBOT state information calculated based on the SOBOT breeding information or the SOBOT birth place information.

By providing the above-described construction, the SOBOT program stored at the SOBOT program storage place of the SOBOT service system 100 in accordance with an embodiment of the present invention can allow the SOBOT service system 100 to supply the SOBOT service by being downloaded at the computer 10 and the mobile terminal 20 of the subscriber.

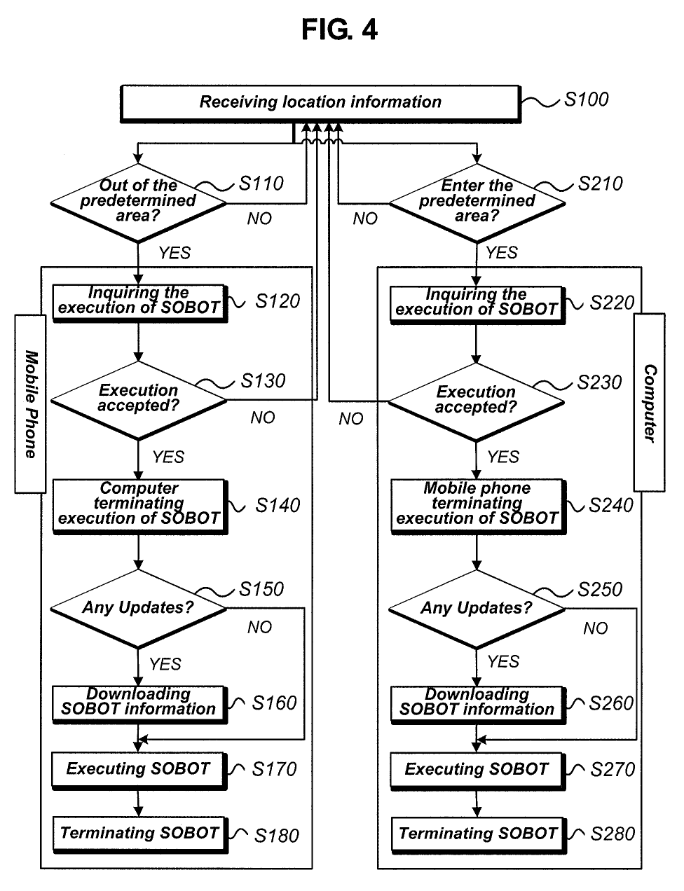

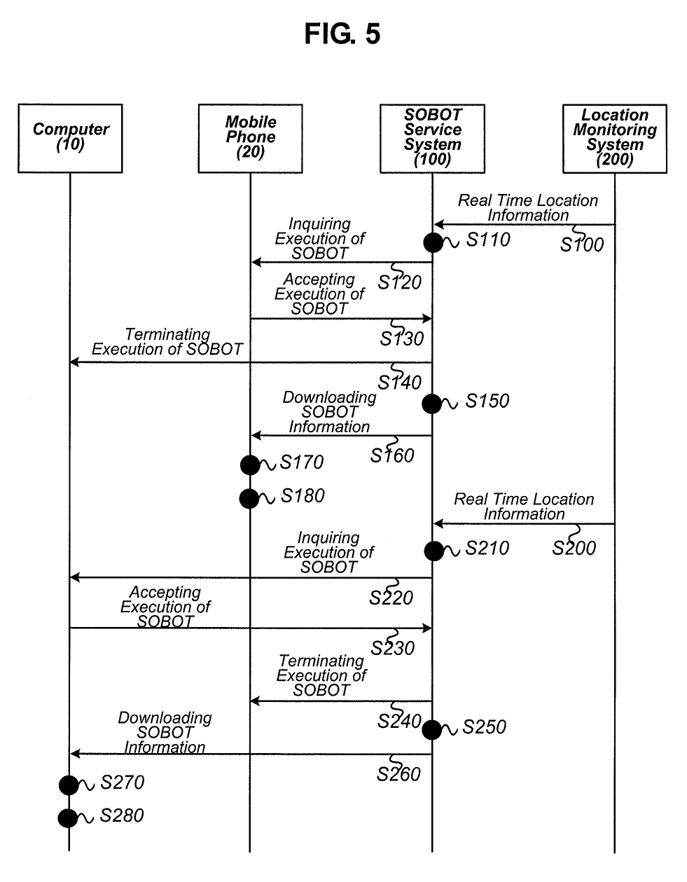

FIG. 4 depicts a flow chart of a SOBOT service method in accordance with one embodiment of the present invention and FIG. 5 illustrates a diagram showing the SOBOT service method shown in FIG. 4 according to network subjects. Referring to FIG. 4 and FIG. 5, the SOBOT service system 100 receives the position information of the mobile terminal 20 of the subscriber from the system 200 (step S100). That is, when the position of the mobile terminal 20 is changed, the changed position is sensed by the system 200 to be transmitted to the SOBOT service system 100.

The SOBOT service system 100 determines whether the mobile terminal 20 deviates from the predetermined area range or enters the predetermined area range based on the received position information (step S110 and step S210). Herein, the predetermined area range is a place such as a home, a company or the like of the subscriber as a place where the computer 10 of the subscriber exists. Therefore, the deviation from the predetermined area region is occurred when the subscriber goes out of home (goes out of office in case for the company) with carrying out the mobile terminal 20, and the entrance of the predetermined area range is occurred when the subscriber returns home (goes to the office in case for the company) with carrying the mobile terminal 20.

As the determination result from step S110 and step S210, in case when neither the mobile terminal 20 enters the predetermined area range nor deviates from the predetermined area range (that is, ‘NO’ at step S110 and ‘NO’ at step S210), it returns back to the step S100 and becomes a state for waiting the reception of the position information.

If it is determined that the mobile terminal 20 is deviated from the predetermined area range as a determination result at the step S110 (‘YES’ at step S110), at first, inquiring to the mobile terminal 20 whether or not to execute the SOBOT program (S120). Herein, if the execution of the SOBOT program is not accepted (‘NO’ at step S130), it becomes a state for waiting the reception of the position information by returning back to step S100.

If the execution of the SOBOT program is accepted in the mobile terminal 20 at step S130 (‘YES’ at step W130), it searches whether the SOBOT program is executed or not, and if the SOBOT program is executed, the program is finished by transmitting an execution finish command of the SOBOT program to the computer 10. Herein, the execution finish command can be transmitted to the computer 10 via a home gateway of the subscriber.

Thereafter, in case when the updated SOBOT information to be transmitted to the mobile terminal 20 exists at the mobile terminal 20 (‘YES’ at step S150), the updated SOBOT information is transmitted to the mobile terminal 20 and the mobile terminal 20 downloads the transmitted SOBOT information (step S160). Herein, the updated SOBOT information, after a final correction time of the SOBOT information stored at the mobile terminal 20, is SOBOT information updated to the database of the SOBOT service system 100. To supply the updated SOBOT information, after the SOBOT information is finally stored by executing the SOBOT program at the mobile terminal, since the SOBOT information can be updated in case when the SOBOT program is executed at the mobile terminal 20, after the SOBOT information updated at this case is supplied to the mobile terminal 20, is to accumulated manage the information of the SOBOT performed at various terminals by executing the SOBOT program at the mobile terminal 20.

If the download of the updated SOBOT information is finished at step S160, the SOBOT program is executed by the execution command of the SOBOT program transmitted to the mobile terminal 20 (step S170). While the SOBOT program is executed, the SOBOT information updated on the mobile terminal 20 is transmitted to the SOBOT service system 100 in real time. According to the cases, the SOBOT information just before the finishing of the SOBOT program can be transmitted in batch. The SOBOT program automatically executed at the mobile terminal 20 when the subscriber goes out of home as like this is manually finished by a command of the subscriber or is automatically finished when the subscriber returns home and the mobile terminal 20 enters the predetermined area range (step S180).

If it is determined that the mobile terminal 20 enters the area range from the determination result at step S210 (‘YES’ at step S210), at first, the execution status of the SOBOT program is inquired to the computer 10 (step S220). Herein, if the execution of the SOBOT program is not accepted (‘NO’ at step S230), it becomes a state for waiting the reception of the position information by returning back to step S100.

If the execution of the SOBOT program is accepted in the mobile terminal 20 at step S230 (‘YES’ at step S230), it is searched whether the SOBOT program is executed at the mobile terminal 20, and if the SOBOT program is executed, the program is finished by transmitting the execution finish command of the SOBOT program (S240).

Thereafter, if the updated SOBOT information to be transmitted to the mobile terminal 20 exists (‘YES’ at step S250), the updated SOBOT information is transmitted to the computer 10 and the computer 10 downloads the transmitted updated SOBOT information (step S260). Herein, the updated SOBOT information, after a final correction time of the SOBOT information stored at the computer, is SOBOT information updated at the database of the SOBOT service system 100.

If the download of the updated SOBOT information is finished at step S260, the SOBOT program is executed by the SOBOT program execution command transmitted to the computer 10 (step S270). Herein, the execution command can be transmitted to the computer 10 via the home gateway of the subscriber. While the SOBOT program is executed, the SOBOT information updated on the computer 10 can be transmitted to the SOBOT service system 100 in real time. As like this, when the subscriber returns home, the SOBOT program automatically executed at the computer 10 is manually finished by the command of the subscriber or automatically finished when the subscriber returns home and deviates from the predetermined area range (step S280).

By proceeding the above-described steps, the SOBOT service method in accordance with one embodiment of the present invention can supply the SOBOT service to automatically move between the computer 10 and the mobile terminal 20 of the subscriber.

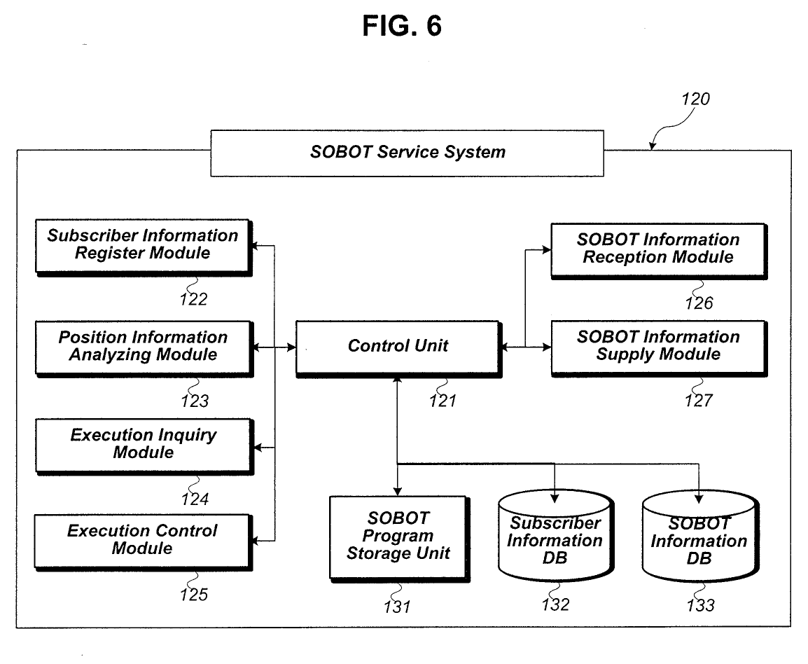

FIG. 6 is a construction diagram of a SOBOT service system in accordance with another embodiment of the present invention.

Referring to the drawing, the SOBOT service system 120 includes a control unit 121, a subscriber information register module 122, a position information reception module 123, an execution inquiry module 124, an execution control module 125, a SOBOT information reception module 126, and a SOBOT information supply module 127, and further includes a SOBOT program storage unit 131, a subscriber information database 132, and a SOBOT information database 133.

If the deviation information of the mobile terminal 20 is received by the position information reception module 123, a SOBOT program execution finish command can be transmitted to the computer 10 by calling the execution control module 125 and a SOBOT program execution command and updated SOBOT information are transmitted to the mobile terminal 20 by calling the execution control module 125 and the SOBOT information supply module 127. And also, if the entrance information of the mobile terminal 20 is received by the position information reception module 123, the SOBOT program execution finish command is transmitted to the mobile terminal 20 by calling the execution control module 125 and the SOBOT program execution command and the updated SOBOT information are transmitted to the computer 10 by calling the execution control module 125 and the SOBOT information supply module 127.

The position information reception module 123 is a module to receive deviation information or entrance information of the subscriber mobile terminal 20 from the system 200. That is, it stores information related to the area range of the subscriber at the system 200, after the system 200 determines whether the subscriber deviates from a predetermined area range, e.g., home or company, or enters the predetermined area range based on the position information to be received in real time, and the deviation information or the entrance information is transmitted to the SOBOT service system 120 when the mobile terminal 20 deviates from the area range or enters the area range. Accordingly, the position information reception module 123 of the SOBOT service system 120 receives the deviation information or the entrance information to control the execution of the SOBOT program of the computer 10 or the mobile terminal by the SOBOT service system 120.

On the other hand, since the subscriber information register module 122, the execution inquiry module 124, the execution control module 125, the SOBOT information reception module 126, the SOBOT information supply module 127, the SOBOT program storage unit 131, the subscriber information database 132 and the SOBOT information database 133 included in the SOBOT service system 120 in accordance with another embodiment of the present invention are similar to the subscriber information register module 102, the execution inquiry module 104, the execution control module 105, the SOBOT information reception module 106, the SOBOT information supply module 107, the SOBOT program storage unit 111, the subscriber information database 112 and the SOBOT information database 113 included in the SOBOT service system 100 in accordance with one embodiment of the present invention, detailed descriptions for these will be omitted.

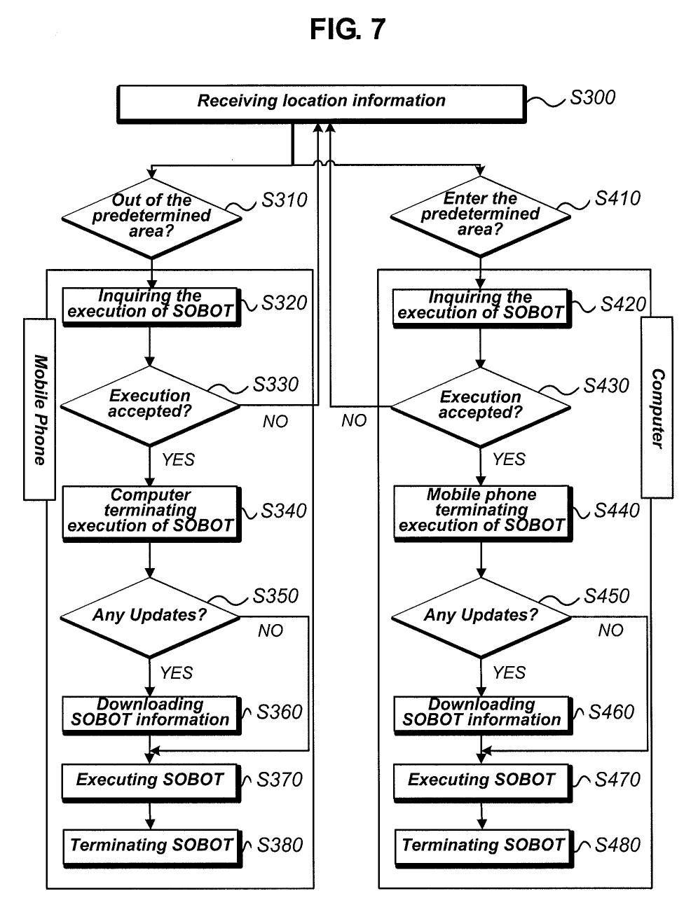

FIG. 7 is a flow chart of a SOBOT service method in accordance with another embodiment of the present invention. Referring to FIG. 7, the SOBOT service system 120 receives the position information of the mobile terminal 20 from the system 200 (step S300). If the SOBOT service system 120 receives the deviation information from the system 200 (step S310), this embodiment of the present invention precedes steps below step S320, and if the SOBOT service system 120 receives the entrance information (step S410), this embodiment of the present invention precedes steps below step S420.

Herein, since the steps below S320 are preceded similar to those below step S120 in the SOBOT service method in accordance with one embodiment of the present invention and the steps below S420 are preceded similar to those below step S220 in the SOBOT service method in accordance with one embodiment of the present invention, the detailed description for these will be omitted.

By preceding the above-described steps the SOBOT service method in accordance with an embodiment of the present invention can supply a SOBOT service to automatically move between the computer 10 and the mobile terminal 20 of the subscriber.

While embodiments have been described, it will be apparent to those skilled in the art that various changes and modifications may be made without departing from the scope of the invention as defined in the following claims.

What is claimed is:

1. A method for servicing a SOBOT (SOftware roBOT) to automatically move the SOBOT between a mobile terminal and a computer placed at a predetermined area range based on position information of the mobile terminal by a SOBOT service system connected to a system, the method comprising:
(a) receiving position information of a mobile terminal of a subscriber in real time from the system;
(b) determining whether the mobile terminal is deviated from the predetermined area range or enters the predetermined area range based on the position information of the step (a); and
(c) selecting any one of the following steps (c1) and (c2):
(c1) if the mobile terminal is deviated from the predetermined area range as a result determined at the step (c1), after an execution finish command of a SOBOT program is transmitted to the computer of the subscriber, transmitting an update SOBOT information and the execution command of the SOBOT program to the mobile terminal; and
(c2) if the mobile terminal enters the predetermined area range as a result determined at the step (c1), after an execution finish command of a SOBOT program is transmitted to the mobile terminal, transmitting the update SOBOT information and the execution command of the SOBOT program to the computer.

2. The method as recited in claim 1, wherein the updated SOBOT information at the step (c1) is SOBOT information updated at a database of the SOBOT system after a final correction time of the SOBOT information stored at the mobile terminal and the updated SOBOT information at the step (c2) is SOBOT information updated at the database of the SOBOT service system after the final correction time of the SOBOT information stored at the computer.

3. The method as recited in claim 2, wherein
the step (c1) includes:
inquiring of the mobile terminal whether or not to execute the SOBOT program when the mobile terminal is deviated from the predetermined area region as a result determined from the step (b); and
transmitting the update SOBOT information and the execution program of the SOBOT program to the mobile terminal, when the subscriber accepts the execution of the SOBOT program through the mobile terminal, after an execution finish command of the SOBOT program is transmitted to the computer of the subscriber; and
the step (c2) includes:
inquiring of the computer of the subscriber whether or not to execute the SOBOT program when the mobile terminal enters the predetermined area region as a result determined from the step (b); and
transmitting the update SOBOT information and the execution command of the SOBOT program to the computer, when the subscriber accepts the execution of the SOBOT program through the computer of the subscriber, after the execution finish command of the SOBOT program is transmitted to the mobile terminal.

4. The method as recited in claim 1, wherein
the step (c1) includes:
inquiring of the mobile terminal whether or not to execute the SOBOT program when the mobile terminal is deviated from the predetermined area region as a result determined from the step (b); and
transmitting the update SOBOT information and the execution program of the SOBOT program to the mobile terminal, when the subscriber accepts the execution of the SOBOT program through the mobile terminal, after an execution finish command of the SOBOT program is transmitted to the computer of the subscriber; and
the step (c2) includes:
inquiring of the computer of the subscriber whether or not to execute the SOBOT program when the mobile terminal enters the predetermined area region as a result determined from the step (b); and
transmitting the update SOBOT information and the execution command of the SOBOT program to the computer, when the subscriber accepts the execution of the SOBOT program through the computer of the subscriber, after the execution finish command of the SOBOT program is transmitted to the mobile terminal.

5. The method as recited in claim 1, before the step (a), further comprising the steps of:
applying a service subscription by inputting information of the subscriber including the mobile terminal of the subscriber by being connected to the SOBOT service system through the computer of the subscriber; and
registering the predetermined area range by the subscriber based on a position information when the SOBOT service system receives the position information of the mobile terminal of the subscriber from the system and transmits the received position information to the computer.

6. The method as recited in claim 5, before the step (a) and after a step of registering the predetermined area range, further comprising the steps of:
transmitting the SOBOT program to the computer and the mobile terminal, wherein the SOBOT program includes:
a control unit for controlling each module;
a breeding unit supplying module for supplying a breeding unit of the SOBOT to the subscriber;
a breeding information reception module for receiving breeding information inputted from the subscriber;
a SOBOT state display module for calculating a current state and/or a behavior of the SOBOT based on the SOBOT information to display the calculated results;
a SOBOT information transmission module for transmitting the updated SOBOT information to the SOBOT service system; and
an execution control module for executing or finishing a program receiving an execution command or an execution finish command of the SOBOT program from the SOBOT service system.

7. The method as recited in claim 1, wherein the execution finish command of the SOBOT program at the step (c1) is to be transmitted to the computer of the subscriber via a home gateway of the subscriber and the execution command of the SOBOT program at the step (c2) is to be transmitted to the computer of the subscriber via a home gateway of the subscriber.

8. A system for servicing a SOBOT (SOftware roBOT) to automatically move the SOBOT between a mobile terminal and a computer placed at a predetermined area range based on position information of the mobile terminal linked to a system, the system comprising:
a subscriber information database at which area range information is stored according to each of subscriber mobile terminals;
a position information analyzing module for receiving position information of the subscriber mobile terminal from the system in real time and for determining whether the mobile terminal is deviated from the predetermined area range or enters the predetermined area range by searching the area region of the subscriber mobile terminal stored at the subscriber information database;
an execution control module for controlling an execution and a finish of the SOBOT program by transmitting the mobile terminal of the subscriber or a SOBOT program execution command or a SOBOT program execution finish command to the computer through an information communication network;
a SOBOT information reception module for receiving SOBOT information from the mobile terminal or the computer while executing the SOBOT program at the mobile terminal or the computer and for storing the received SOBOT information at the data base;
a SOBOT information supplying module for transmitting the updated SOBOT information among the SOBOT information stored at the database to the mobile terminal or the computer; and
a control unit for transmitting the SOBOT program execution command and the updated SOBOT information to the computer by calling the execution control module and the SOBOT information supplying module, wherein the control unit transmits the SOBOT program execution finish command to the computer by calling the execution control module when it is determined by the position information analyzing module that the mobile terminal deviates from the predetermined area region, the control unit transmits the SOBOT program execution command and the updated SOBOT information to the mobile terminal by calling the execution control module and the SOBOT information supplying module, and the control unit transmits the SOBOT program execution finish command to the mobile terminal by calling the execution control module when it is determined by the position information analyzing module that the mobile terminal enters the predetermined area region.

9. The system as recited in claim 8, further comprising an execution inquiry module, after inquiring of the computer of the subscriber or the mobile computer whether or not to execute the SOBOT program, for receiving the result and transmitting the received result to the execution control module,
wherein the execution control module is a module the SOBOT program execution command and the SOBOT program execution finish command are transmitted to the mobile terminal or the computer only in case of data related to the execution acceptance is received by the execution inquiry module.

10. The system as recited in claim 8, wherein the SOBOT program includes:
a breeding unit supplying module for supplying a plurality of units to breed the SOBOT by the subscriber;
a breeding information reception module, if the subscriber selects at least one among the breeding units through an input device of the computer or the mobile terminal;
a SOBOT information database for storing a previously set SOBOT birth place information, the SOBOT breeding information stored by the breeding information reception module and SOBOT state information according to the previously set SOBOT birth place information and/or the SOBOT breeding information;
a SOBOT image database for storing files of images such as a picture, a drawing or a moving picture of the SOBOT according to a state or a behavior of the SOBOT;
a SOBOT state display module for calculating a current state of the SOBOT based on the SOBOT information stored at the SOBOT information database and reading the images matching to the current state and/or the behavior of the SO BOT from the SOBOT image database to display the read images;
a SOB OT information transmission module for transmitting the SOBOT information updated at the SOBOT information database during the execution of the SOBOT program to the SOBOT service system through the information communication network; and
an execution control module for controlling an execution and a finish of the program according to an execution command or an execution finish command of the SOBOT program from the SOBOT service system.

11. The system as recited in claim 10, wherein the files of images such as a picture, a drawing or a moving picture of the SOBOT includes an image file of a pet or an image file of a person.

12. A method for servicing a SOBOT (SOftware roBOT) to automatically move the SOBOT between a mobile terminal and a computer placed at a predetermined area range based on position information of the mobile terminal by a SOBOT service system connected to a system, the method comprising:
(a) if the system transmits deviation information or entrance information of the mobile terminal of a subscriber, receiving the transmitted information;
(b) selecting any one of the following steps (c1) and (c2):
(b1) if the deviation information is received at the step (a), after an execution finish command of a SOBOT program is transmitted to the computer of the subscriber, transmitting an update SOBOT information and an execution command of the SOBOT program to the mobile terminal; and
(b2) if the entrance information is received at the step (a), after an execution finish command of a SOBOT program is transmitted to the mobile terminal, transmitting the update SOBOT information and the execution command of the SOBOT program to the computer.

13. A system for servicing a SOBOT (SOftware roBOT) to automatically move the SOBOT between a mobile terminal and a computer placed at a predetermined area range based on position information of the mobile terminal linked to a system, the system comprising:
a position information reception module for receiving deviation information or entrance information of the mobile terminal of a subscriber from the system;
an execution control module for controlling an execution and a finish of the SOBOT program by transmitting the mobile terminal of the subscriber or a SOBOT program execution command or a SOBOT program execution finish command to the computer through an information communication network;
a SOBOT information reception module for receiving SOBOT information from the mobile terminal or the computer while executing the SOBOT program at the mobile terminal or the computer and for storing the received SOBOT information at the data base;
a SOBOT information supplying module for transmitting the updated SOBOT information among the SOBOT information stored at the database to the mobile terminal or the computer; and
a control unit for transmitting the SOBOT program execution command and the updated SOBOT information to the computer by calling the execution control module and the SOBOT information supplying module, wherein the control unit transmits the SOBOT program execution finish command to the computer by calling the execution control module when the deviation information of the mobile terminal is received by the position information reception module, the control unit transmits the SOBOT program execution command and the updated SOBOT information to the mobile terminal by calling the execution control module and the SOBOT information supplying module, and the control unit transmits the SOBOT program execution finish command to the mobile terminal by calling the execution control module when the entrance information is received by the position information reception module.
